(19) United States
(12) Patent Application Publication
(10) Pub. No.: US 2007/0045342 A1
(43) Pub. Date: Mar. 1, 2007

(54) APPARATUS AND METHODS FOR MULTI-FLUID DISPENSING SYSTEMS

(76) Inventors: Anthony Pigliacampo, Menlo Park, CA (US); Aaron Henningsgaard, Palo Alto, CA (US); Christian Hartmann Griffith, Boulder, CO (US)

Correspondence Address: LAW OFFICE OF JAMES TROSINO, 92 NATOMA STREET, SUITE 211, SAN FRANCISCO, CA, 94105, US

(21) Appl. No.: 11/467,511

(22) Filed: Aug. 25, 2006

Related U.S. Application Data
(60) Provisional application No. 60/712,328, filed on Aug. 29, 2005.

(51) Int. Cl. B67D 5/56; B65D 35/22; B67D 5/52

(52) U.S. Cl. 222/129; 222/94; 222/209; 222/136

(57) ABSTRACT

Apparatus and methods are provided for selectively dispensing first and second liquids from a bottle. A cap including a first opening is coupled to a mouth of the bottle, and a first valve is coupled to the first opening. The first valve includes a first position, wherein the first liquid may be dispensed from the bottle, and a second position, wherein the first liquid is substantially sealed in the bottle. A container containing a second liquid is coupled to the first opening. The container includes a second opening, and is adapted to be inserted through the mouth into the bottle. A second valve is coupled to the second opening. The second valve is adapted to close when a difference between a pressure inside the container and a pressure outside the container is less than a predetermined amount, and to open when the pressure difference is greater than the predetermined amount, wherein the second liquid may be dispensed from the container when the first valve is in the closed position.

### REFERENCE TO RELATED APPLICATIONS

This application claims the benefit of U.S. Provisional Application Ser. No. 60/712,328, filed 29 Aug. 2005, the entire contents of which is incorporated by reference herein in its entirety.

### BACKGROUND

The invention pertains to apparatus and methods for dispensing liquids. More particularly, this invention pertains to apparatus and methods for dispensing multiple liquids, such as water and a nutritional gel, from a sports bottle.

In recent years, bottled water has become increasingly popular not only for satisfying thirst, but also for staying hydrated. In particular, sports enthusiasts, such as runners and cyclists, typically consume water or other beverages from sports bottles during exercise to prevent dehydration. In addition, many sports enthusiasts consume nutritional gels that include concentrated liquefied carbohydrates and other supplements for nutrients consumed during rigorous exercise. Nutritional gels are often packaged in small foil pouches that may be easily stored and transported. Although the pouches are small and lightweight, many sports enthusiasts find it cumbersome or inconvenient to separately carry both a sports bottle and one or more nutritional gels during exercise. Indeed, cyclists typically seek to minimize the amount of gear that they must carry during races and other routines.

One way to overcome this multiple packaging problem is to mix the water and nutritional gel and then carry the mixture in a single sports bottle. Although such a solution allows a user to carry a single container, this solution is less than ideal. First, many people do not like the taste of the water-gel mixture, and therefore may under-hydrate during exercise. Further, if a user does not consume the entire liquid mixture during exercise, the user may not fully replenish expended nutrients.

In view of the foregoing, it would be desirable to provide a single sports bottle that allows a user to separately store and dispense multiple fluids, such as water and nutritional gels.

### SUMMARY

This invention provides apparatus and methods for selectively dispensing first and second liquids from a first container, such as a sports bottle, that includes the first liquid. In particular, a cap including a first opening is adapted to be coupled to a mouth of the first container, and a first valve is coupled to the first opening. The first valve includes a first position, wherein the first liquid may be dispensed from the first container, and a second position, wherein the first liquid is substantially sealed in the first container. A second container including a second opening is coupled to the first opening. In particular, the second container is adapted to contain the second liquid and to be inserted through the mouth into the first container. A second valve is coupled to the second opening. The second valve is adapted to close when a difference between a pressure inside the second container and a pressure outside the second container is less than a predetermined amount, and to open when the pressure difference is greater than the predetermined amount, wherein the second liquid may be dispensed from the second container when the first valve is in the closed position.

In one exemplary embodiment, the second container includes a cylindrical tube having open ends. A plunger is slidably inserted into one of the open ends, and forms a bottom of the second container. After the second liquid is inserted into the second container, the second container is coupled to the first opening, and then the second container is inserted into the mouth of the first container. When a user squeezes the first container, or sucks on a stopper coupled to the first opening, the plunger slides inside the cylindrical tube, and causes the pressure inside the second container to increase. When the pressure difference exceeds the predetermined amount, the second liquid is dispensed from the second container.

In an alternative embodiment, the second container includes a pouch, such as a foil pouch containing the second liquid. The pouch is coupled to the first opening, and is then inserted into the mouth of the first container. When a user squeezes the first container, or sucks on a stopper coupled to the first opening, the pouch collapses, and causes the pressure inside the pouch to increase. When the pressure difference exceeds the predetermined amount, the second liquid is dispensed from the pouch.

### BRIEF DESCRIPTION OF THE DRAWINGS

Features of the present invention can be more clearly understood from the following detailed description considered in conjunction with the following drawings, in which the same reference numerals denote the same elements throughout, and in which:

FIG. 1 is a cross-sectional view of an exemplary multi-fluid dispensing system in accordance with this invention;

FIGS. 2A-2D are a top elevation view, a side view, a first cross-sectional view and a second cross-sectional view, respectively, of an exemplary cap of multi-fluid dispensing systems in accordance with this invention;

FIGS. 3A-3C are a top elevation view, a side view, and a cross-sectional view, respectively, of an exemplary stopper of multi-fluid dispensing systems in accordance with this invention;

FIGS. 4A-4D are various cross-sectional views of the stopper and cap of FIGS. 2 and 3;

FIGS. 5A-5C are a top elevation view, a side view, and a cross-sectional view, respectively, of an exemplary lid of multi-fluid dispensing systems in accordance with this invention;

FIGS. 6A-6D are a first top elevation view, a first cross-sectional view, a second top elevation view, and a second cross-sectional view, respectively, of an exemplary second valve of multi-fluid dispensing systems in accordance with this invention;

FIGS. 7A-7C are a top elevation view, a side view, and a cross-sectional view, respectively, of an exemplary second container of multi-fluid dispensing systems in accordance with this invention;

FIGS. 8A-8C are a top elevation view, a side view, and a cross-sectional view, respectively, of an exemplary plunger of multi-fluid dispensing systems in accordance with this invention;

FIG. 9A is a cross-sectional view of an exemplary first container of multi-fluid dispensing systems in accordance with this invention including a first liquid;

FIG. 9B is a cross-sectional view of an exemplary plunger and second container of multi-fluid dispensing systems in accordance with this invention including a second liquid;

FIG. 9C is a cross-sectional view of an exemplary lid assembly of multi-fluid dispensing systems in accordance with this invention coupled to the plunger and second container of FIG. 9B;

FIG. 9D is a cross-sectional view of the lid assembly, plunger and second container of FIG. 9B coupled to the first container of FIG. 9A;

FIG. 10 is an exemplary illustration of the multi-fluid dispensing system of FIG. 9D dispensing the first liquid from the first container;

FIG. 11 is an exemplary illustration of the multi-fluid dispensing system of FIG. 9D dispensing the second liquid from the second container;

FIG. 12 is an exemplary illustration of the multi-fluid dispensing system of FIG. 9D simultaneously dispensing the first liquid from the first container and the second liquid from the second container;

FIGS. 13A-13C are a top elevation view, a side view, and a cross-sectional view, respectively, of an alternative exemplary lid of multi-fluid dispensing systems in accordance with this invention;

FIGS. 14A-14C are a top elevation view, a side view, and a cross-sectional view, respectively, of an alternative exemplary second container of multi-fluid dispensing systems in accordance with this invention;

FIG. 15 is a cross-sectional view an alternative exemplary lid assembly of multi-fluid dispensing systems in accordance with this invention coupled to the lid and second container of FIGS. 13 and 14; and

FIG. 16 is an exemplary illustration of an alternative multi-fluid dispensing system dispensing the second liquid from the second container of FIG. 14.

### DETAILED DESCRIPTION

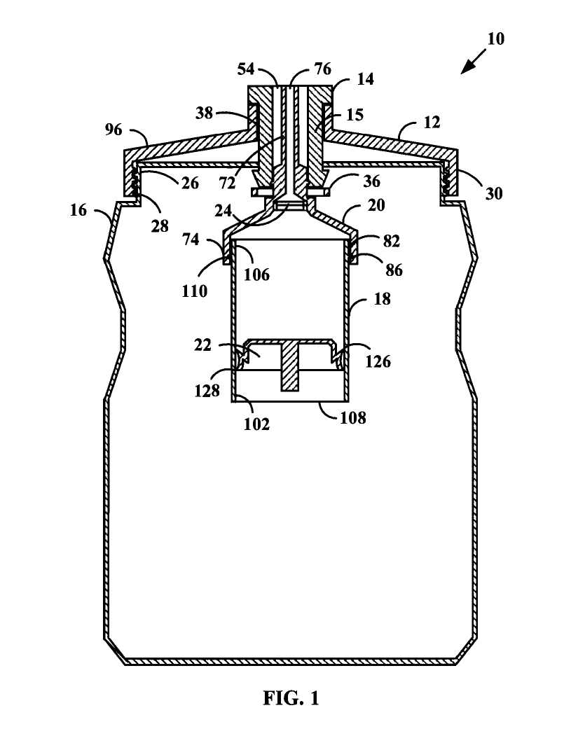

Referring to FIG. 1, an exemplary embodiment of a multi-fluid dispensing system in accordance with this invention is described. Multi-fluid dispensing system 10 includes a cap 12, a stopper 14, a first valve 15, a first container 16, a second container 18, a lid 20, a plunger 22 and a second valve 24. Cap 12 may be coupled to a mouth 26 of first container 16 to form a substantially water-tight seal. For example, mouth 26 may include a threaded portion 28 and cap 12 may include a corresponding threaded portion 30, such that cap 12 may be screwed onto mouth 26 of first container 16. Alternatively, cap 12 may be coupled to first container 16 via a snap fitting or other similar attachment means. First container 16 m ay be a plastic bottle, such as a sports bottle or other similar beverage container.

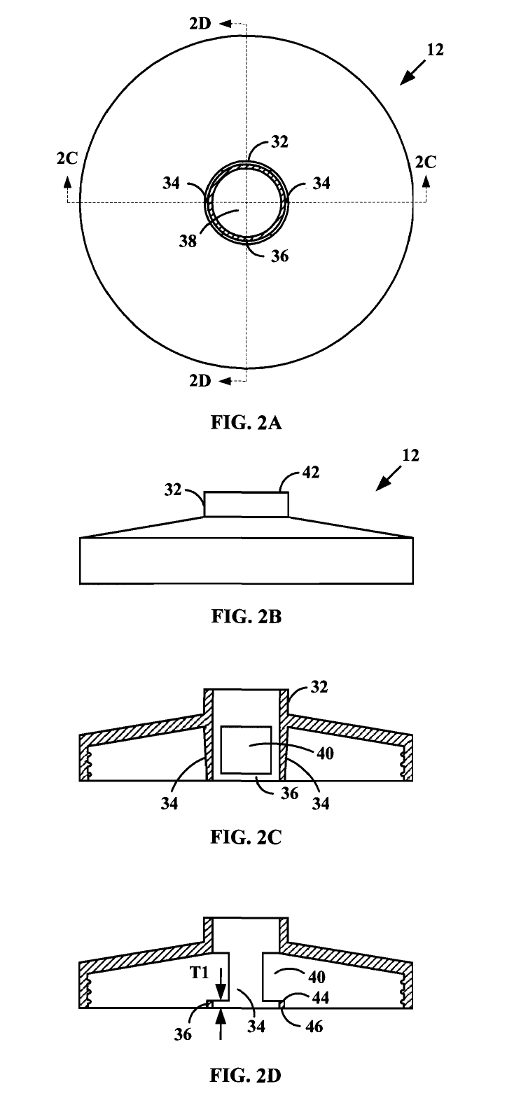

As shown in FIGS. 1 and 2, cap 12 includes mouth 32, arcuate sidewall sections 34 and ring 36. Arcuate sidewall sections 34 each have a first end coupled to mouth 32 and a second end coupled to ring 36. A first opening 38 extends from the top to mouth 32 to the bottom of ring 36. Sidewall openings 40 are formed in the space between mouth 32, arcuate sidewall sections 34 and ring 36. Mouth 32 includes a top surface 42, and ring 36 includes a top surface 44 and a bottom surface 46, and has a thickness T1. Mouth 32, arcuate sidewall sections 34 and ring 36 may be molded from a plastic material, or other similar material.

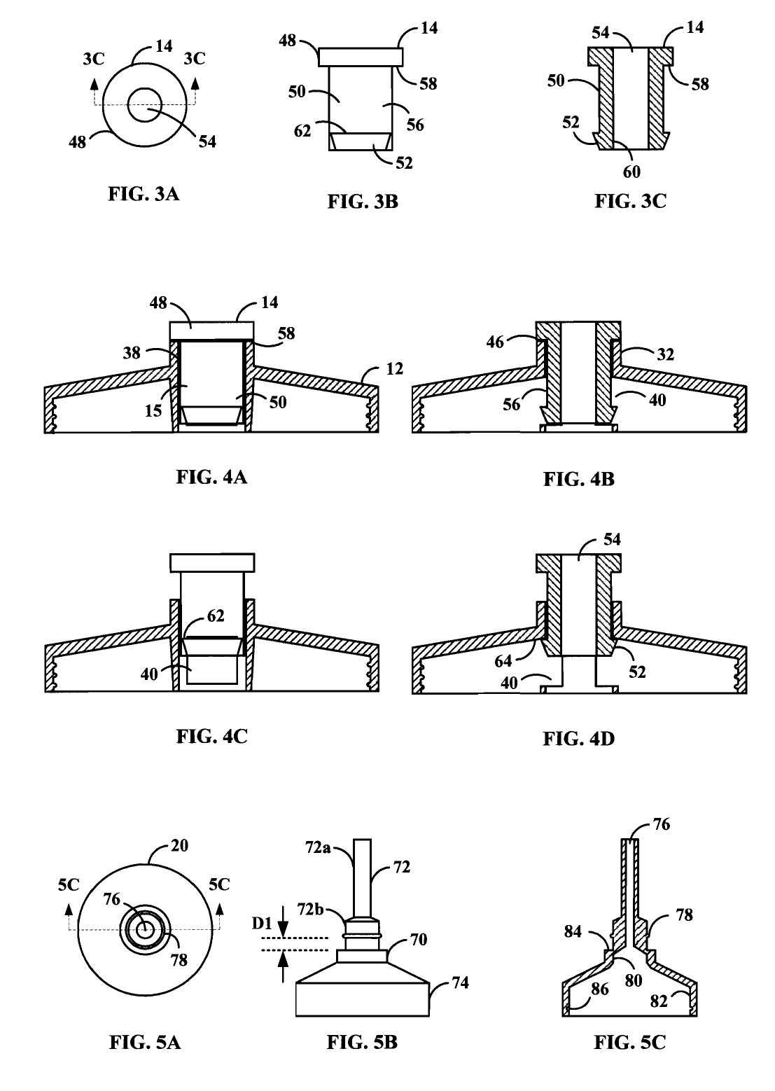

As shown in FIGS. 1 and 3, stopper 14 includes flange 48, stem 50 and side tabs 52. Flange 48 is disposed at one end of stopper 14, and side tabs 52 are disposed at the other end of stopper 14. An aperture 54 is centrally disposed within flange 48 and stem 50, and runs along the long axis of stopper 14. Side tabs 52 extend radially outward from a portion of the circumference of an outer wall 56 of stem 50. Flange 48 includes a bottom surface 58. Aperture 54 includes interior sidewalls 60, and side tabs 52 each include a top surface 62. Flange 48, stem 50 and side tabs 52 of stopper 14 may be molded from a flexible rubber material, or other similar material.

Referring now to FIGS. 1 and 4, first valve 15 is formed by stopper 14 and mouth 32, arcuate sidewall sections 34 and ring 36 of cap 12. In particular, stopper 14 is disposed in opening 38 of cap 12 and may slide along arcuate sidewall sections 34 between mouth 32 and ring 36 to open and close first valve 15. As shown in FIGS. 4A and 4B, when first valve 15 is in a closed position, bottom surface 58 of flange 48 rests against top surface 46 of mouth 32. In this position, outer wall 56 of stem 50 substantially closes sidewall openings 40 of cap 12. In contrast, as shown in FIGS. 4C and 4D, when first valve 15 is in an open position, top surface 62 of side tabs 52 rests against underside 64 of cap 12. In this position, aperture 54 of stopper 14 is in fluid communication with sidewall openings 40.

Referring now to FIG. 5, lid 20 includes a first collar 70 coupled between a stem 72 and a second collar 74. An aperture 76 is centrally disposed within stem 72, first collar 70 and second collar 74, and runs along the long axis of lid 20. Stem 72 includes a first portion 72a at a first end of lid 20, and a second portion 72b coupled to first collar 70. An outer surface of second portion 72b includes a raised rib 78. First collar 70 and second collar 74 include interior sidewalls 80 and 82, respectively. First collar 70 includes a top surface 84, and interior sidewall 82 includes a groove 86. The distance between raised rib 78 and top surface 84 of first collar 70 is D1. First collar 70, stem 72 and second collar 74 of lid 20 may be molded from a plastic material, or other similar material.

As shown in FIG. 1, stem 72 of lid 20 may be inserted through first opening 38 of cap 12 and may be disposed within aperture 54 of stopper 14. In this configuration, top surface 84 of first collar 70 abuts bottom surface 46 of ring 36. In addition, raised rib 78 of second portion 72b has a diameter slightly larger than ring 36. In this regard, as stem 72 is inserted through first opening 38 of cap 12, raised rib 78 may be pushed through ring 36 until raised rib 78 rests above top surface 44 of ring 36. If thickness T1 of ring 36 substantially equals distance D1 between raised rib 78 and top surface 84 of first collar 70, ring 36 acts to securely hold lid 20 within first opening 38 of cap 12.

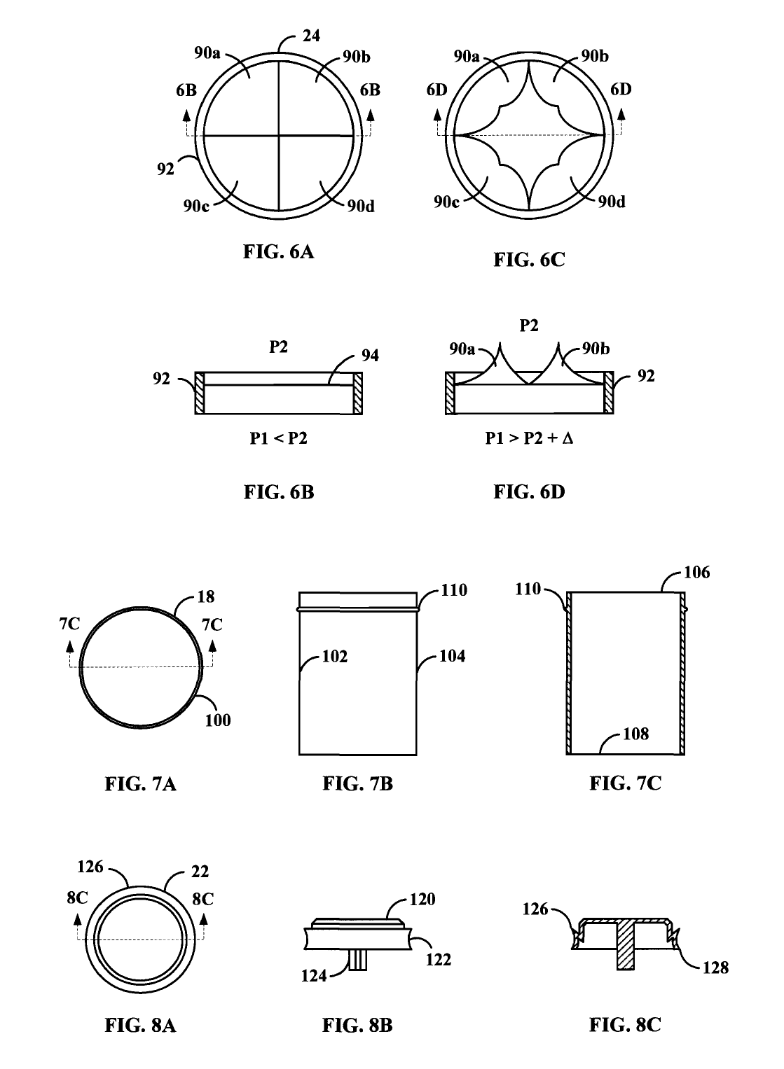

Referring now to FIGS. 1, 5 and 6, a second valve 24 may be disposed within aperture 76 of lid 20. In particular, second valve 24 may be secured to interior sidewall 80 of first collar 70. Second valve 24 may be a bicuspid valve that includes multiple leaves 90a-90b coupled to an interior surface of a support ring 92. As shown in FIGA. 6A and 6C, when a pressure P1 on one side of second valve 24 is less than a pressure P2 on the other side of the valve, leaves 90a-90b form a substantially coplanar surface 94, and second valve 24 is closed. In contrast, as shown in FIGS. 6B and 6D, when pressure P1 exceeds pressure P2 by a predetermined amount Δ, leaves 90a-90b flare away from surface 94, and second valve 24 opens. Second valve 24 may be a V34 silicone SureFlo™ valve manufactured by Liquid Molding Systems, Midland, Mich., USA, or may be any other similar valve. Referring again to FIG. 1, the combination of cap 12, first valve 15, lid 20 and second valve 24 is referred to herein as lid assembly 96.

Referring now to FIG. 7, second container 18 includes a cylindrical tube 100 having an inner surface 102, and an outer surface 104. In addition, second container includes a first end 106 and a second end 108, and a raised rib 110 disposed on outer surface 104 near first end 106. First and second ends 106 and 108, respectively, are open. Second container 18 may be molded from a plastic material, or other similar material. As shown in FIG. 1, first end 106 of second container 18 fits within second collar 74 of lid 20. In particular, raised rib 110 of second container 18 snaps into groove 86 of second collar 74, and outer surface 104 of second container 18 forms a substantially water-tight seal with interior sidewall 82 of second collar 74.

Referring now to FIG. 8, plunger 22 includes top surface 120, concave sidewall 122 and handle 124. Concave sidewall 122 has a first edge 126 and a second edge 128. Plunger 22 may be molded from a plastic material, or other similar material. As shown in FIG. 1, plunger 22 may be inserted into second end 108 of second container 18. First and second edges 126 and 128, respectively, of plunger 22 slidingly engage inner surface 102 of second container 18. In addition, as described in more detail below, after a liquid is inserted into second container 18, first and second edges 126 and 128 form a substantially water-tight seal with inner surface 102 of second container 18.

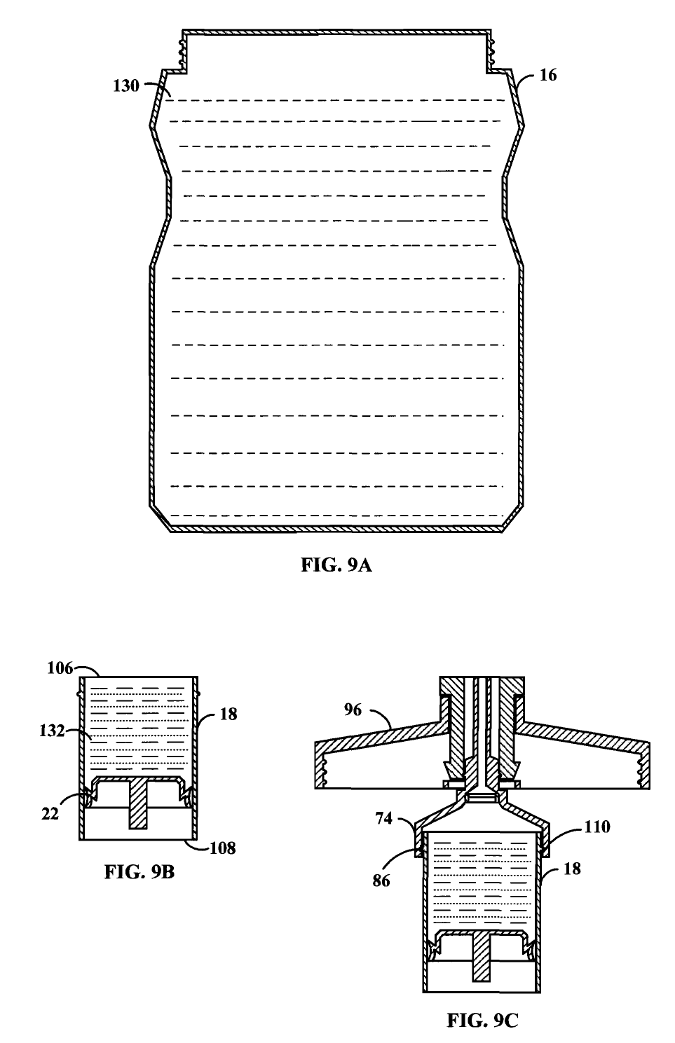

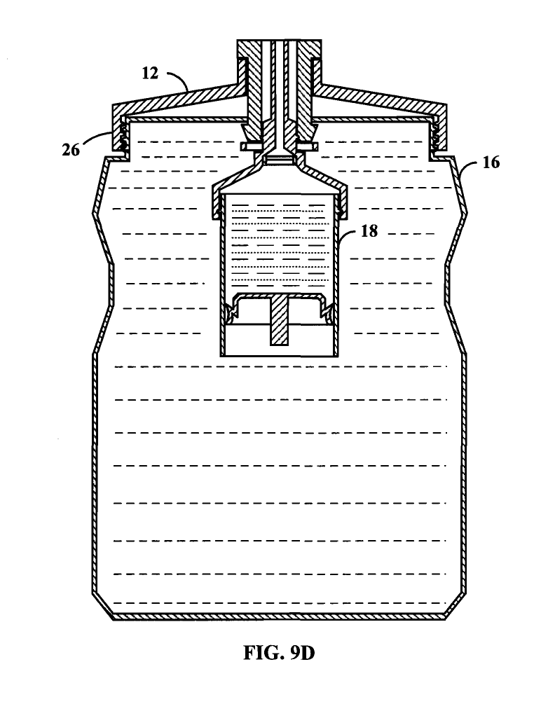

Referring now to FIG. 9, an exemplary method of using multi-fluid dispensing system 10 is described. First, as shown in FIG. 9A, a first liquid 130 is inserted into first container 16. First liquid 130 may be water, soda, coffee, tea, alcohol, Gatorade, or any other liquid. Next, as shown in FIG. 9B, plunger 22 is inserted into second end 108 of second container 18, and a second liquid 132 is then poured into first end 106 of second container 18. Second fluid 132 may be water, soda, coffee, tea, alcohol, Gatorade, a nutritional gel, or any other liquid. Second liquid 132 typically is different from first liquid 130, but the two liquids may be the same liquid. Second liquid 132 fills in any spaces and forms a substantially water-tight seal between first and second edges 126 and 128 of plunger 22 and inner surface 102 of second container 18. Next, as shown in FIG. 9C, second container 18 is coupled to lid assembly 96. In particular, first end 106 of second container 18 is inserted into second collar 74 of lid 20, until raised rib 110 snaps into groove 86. Finally, as shown in FIG. 9D, second container 18 is inserted into first container 16, and cap 12 is securely coupled to mouth 26.

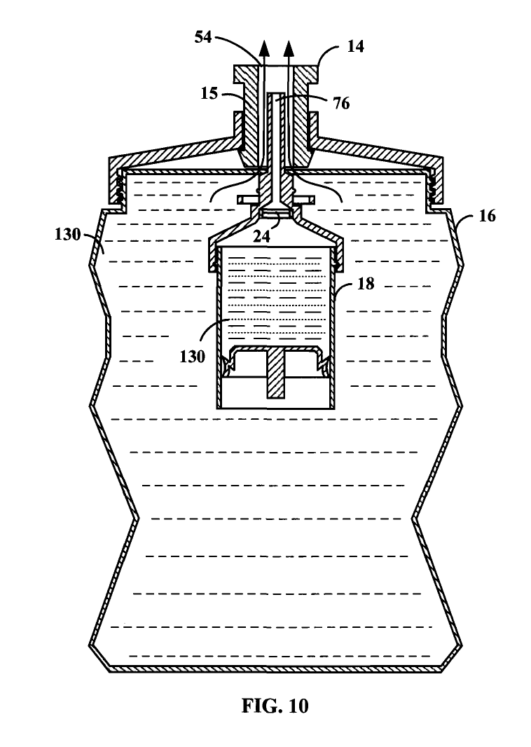

Referring now to FIG. 10, the operation of multi-fluid dispensing system 10 to dispense first liquid 130 described. In particular, if a user opens first valve 15 and then squeezes the outside of first container 16, the pressure inside first container 16 increases, and first liquid 130 is expelled through sidewall openings 40 of cap 12 and out of aperture 54 of stopper 14. The pressure inside second container 18 remains substantially the same as the pressure in aperture 76, and second valve 24 remains closed. Second liquid 132 therefore remains inside second container 18. Thus, in this configuration, a user may dispense first liquid 130 from first container 16 without dispensing second liquid 132 from second container 18.

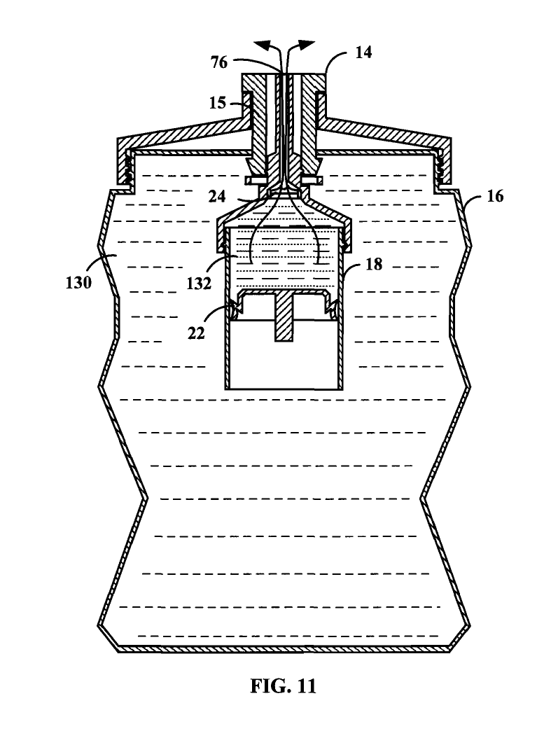

Referring now to FIG. 11, the operation of multi-fluid dispensing system 10 to dispense second liquid 132 described. In particular, if a user closes first valve 15, stem 50 substantially closes sidewall openings 40 of cap 12, and first liquid 130 remains inside first container 16. If the user squeezes the outside of first container 16, the pressure inside first container 16 increases, causing plunger 22 to move toward second end 108 of second container 18, and increasing the pressure inside second container 18. When the pressure inside second container 18 exceeds the pressure in aperture 76 by the predetermined amount Δ, second valve 24 opens, and second liquid 132 flows through aperture 76 of lid 20. Thus, in this configuration, a user may dispense second liquid 132 from second container 18 without dispensing first liquid 130 from first container 16.

As described above, second valve 24 opens whenever an appropriate pressure differential is created across opposite sides of second valve 24. Persons of ordinary skill in the art will understand, therefore, that a user also may dispense second liquid 132 from second container 18 by sucking on stopper 14. If the user applies sufficient suction to stopper 14, such the pressure in aperture 76 is less than the pressure inside second container 18 minus Δ, second valve 24 will open, plunger 22 will move toward second end 108 of second container 18, and second liquid 132 will flow through aperture 76 of lid 20.

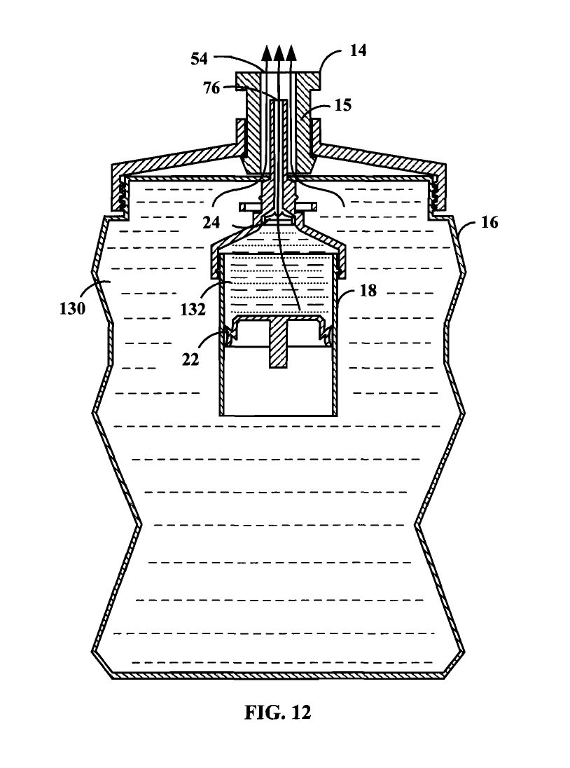

Referring now to FIG. 12, the operation of multi-fluid dispensing system 10 to simultaneously dispense first liquid 130 and second liquid 132 described. In particular, if a user opens first valve 15 and then squeezes the outside of first container 16, the pressure inside first container 16 increases, and first liquid 130 is expelled through sidewall openings 40 of cap 12 and out of aperture 54 of stopper 14. At the same time, if a user applies sufficient suction to stopper 14 (e.g., by sucking on stopper 14), second valve 24 opens, plunger 22 moves toward second end 108 of second container 18, and second liquid 132 is expelled through aperture 76 of lid 20. Thus, in this configuration, a user may simultaneously dispense first liquid 130 from first container 16 and second liquid 132 from second container 18.

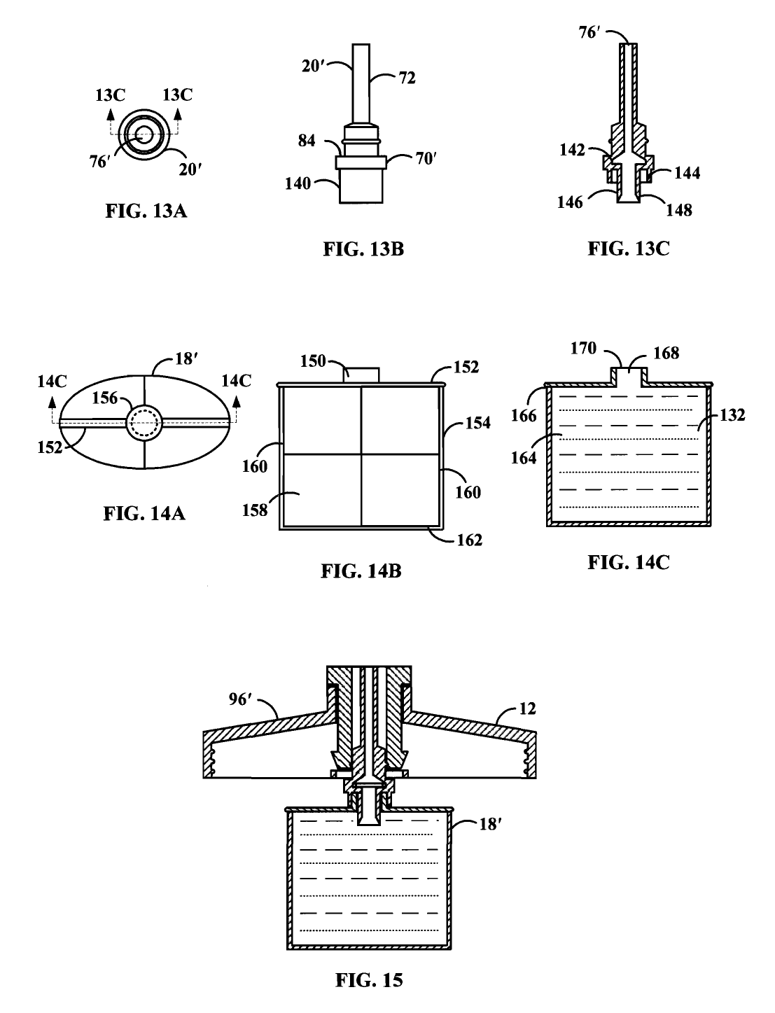

Referring now to FIG. 13 and 14, an alterative embodiment of lid 20 and second container 18 is described. In particular, as shown in FIGS. 13A-13C, lid 20′ includes a first collar 70′ coupled between stem 72 and a cuff 144. An aperture 76′ is centrally disposed within stem 72, first collar 70′ and cuff 140, and runs along the long axis of lid 20′. First collar 70′ and cuff 140 include interior sidewalls 142 and 144, respectively. First collar 70′ includes top surface 84, and cuff 140 includes a blade 146 having a cutting edge 148. First collar 70′, stem 72 and cuff 140 may be molded from a plastic material, or other similar material.

As shown in FIG. 14, second container 18′ includes a stem 150 coupled to a clamp 152 and a pouch 154. Stem 150 may by a hollow cylindrical tube that includes an outer surface 156. Pouch 154 has a sidewall 158 that is sealed along both sides 160 and along a bottom 162 edge to form an interior chamber 164 that includes second liquid 132. Clamp 152 seals a top edge 166 of pouch 154. An aperture 168 extends through stem 150 and an opening in clamp 152, and is in fluid communication with interior 164 of pouch 154. A membrane 170 seals aperture 158 at a top end of stem 150. Stem 150 and clamp 152 may be molded from a plastic material, or other similar material. Pouch 154 may be made from foil, plastic, or other similar material. Membrane 170 may be a thin sheet of foil, plastic or other similar material.

As shown in FIG. 15, second valve 24 may be inserted into aperture 76′ of lid 20′, and stem 72 of lid 20′ may be inserted through first opening 38 of cap 12 and disposed within aperture 54 of stopper 14 to form lid assembly 96′. Lid assembly 96′ then may be coupled to second container 18′. In particular, cutting edge 148 of blade 146 may be used to puncture membrane 170 of second container 18′, and cuff 140 may then slide over stem 150. Interior sidewall 144 of cuff 140 forms a snug fit against the outer surface 156 of stem 150, so that second container 18′ is securely attached to lid 20′.

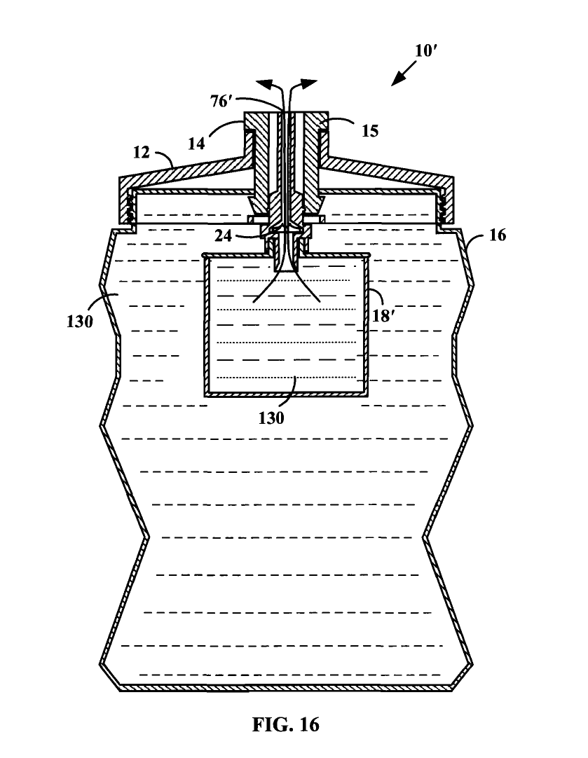

As illustrated in FIG. 16, second container 18′ may then be inserted into first container 16, and cap 12 may then be securely coupled to mouth 26 to form multi-fluid dispensing system 10′. The operation of multi-fluid dispensing system 10′ to dispense first liquid 130 is the same as described above in connection with multi-fluid dispensing system 10. To dispense second liquid 132 from second container 18′, a user closes first valve 15 to seal first liquid 130 inside first container 16. If the user then squeezes the outside of first container 16, the pressure inside first container 16 increases, causing pouch 154 to collapse, increasing the pressure inside second container 18′. When the pressure inside second container 18′ exceeds the pressure in aperture 76′ by the predetermined amount Δ, second valve 24 opens, and second liquid 132 flows through aperture 76′ of lid 20′. A user alternatively may dispense second liquid 132 from second container 18′ by sucking on stopper 14.

The foregoing merely illustrates the principles of this invention, and various modifications can be made by persons of ordinary skill in the art without departing from the scope and spirit of this invention.

1. Apparatus for use with a first container used to contain a first liquid, the apparatus comprising:
a cap adapted to be coupled to a mouth of the first container, the cap comprising a first opening;
a first valve coupled to the first opening, the first valve comprising a first position, wherein the first liquid may be dispensed from the first container, and a second position, wherein the first liquid is substantially sealed in the first container;
a second container coupled to the first opening, the second container adapted to contain a second liquid and comprising a second opening, wherein the second container is adapted to be inserted through the mouth into the first container;
a second valve coupled to the second opening, the second valve adapted to close when a difference between a pressure inside the second container and a pressure outside the second container is less than a predetermined amount, and to open when the pressure difference is greater than the predetermined amount, wherein the second liquid may be dispensed from the second container when the first valve is in the closed position.

2. The apparatus of claim 1, wherein the second container comprises a cylindrical tube.

3. The apparatus of claim 2, wherein the cylindrical tube comprises a first end comprising an opening, the first end adapted to be coupled to the cap.

4. The apparatus of claim 2, wherein the cylindrical tube comprises a second end comprising an opening, and the second container further comprises a bottom removably insertable into the second end.

5. The apparatus of claim 2, wherein the cylindrical tube comprises interior sidewalls, and the second container further comprises a plunger adapted to sealingly and slidably engage the interior sidewalls of the cylindrical tube.

6. The apparatus of claim 5, wherein the cylindrical tube further comprises a second end comprising an opening, and the plunger is adapted to slide from the second end to the first end.

7. The apparatus of claim 5, wherein movement of the plunger within the cylindrical tube creates the pressure differential.

8. The apparatus of claim 1, wherein the second valve comprises a bicuspid valve.

9. The apparatus of claim 1, wherein the second container comprises a collapsible bag.

10. The apparatus of claim 1, wherein the pressure difference may be caused by a user squeezing the first container.

11. The apparatus of claim 1, wherein the first valve comprises a stopper having an internal aperture, and the pressure difference may be caused by a sucking on the stopper.

12. A bottle for selectively dispensing first and second liquids, the bottle comprising:
a cap adapted to be coupled to a mouth of the bottle, the cap comprising a first opening;
a first valve coupled to the first opening, the first valve comprising a first position, wherein the first liquid may be dispensed from the bottle, and a second position, wherein the first liquid is substantially sealed in the bottle;
a container coupled to the first opening, the container adapted to contain a second liquid and comprising a second opening, wherein the container is adapted to be inserted through the mouth into the bottle;
a second valve coupled to the second opening, the second valve adapted to close when a difference between a pressure inside the container and a pressure outside the container is less than a predetermined amount, and to open when the pressure difference is greater than the predetermined amount, wherein the second liquid may be dispensed from the container when the first valve is in the closed position.

13. The bottle of claim 12, wherein the container comprises a cylindrical tube.

14. The bottle of claim 13, wherein the cylindrical tube comprises a first end comprising an opening, the first end adapted to be coupled to the cap.

15. The bottle of claim 13, wherein the cylindrical tube comprises a second end comprising an opening, and the second container further comprises a bottom removably insertable into the second end.

16. The bottle of claim 13, wherein the cylindrical tube comprises interior sidewalls, and the second container further comprises a plunger adapted to sealingly and slidably engage the interior sidewalls of the cylindrical tube.

17. The bottle of claim 16, wherein the cylindrical tube further comprises a second end comprising an opening, and the plunger is adapted to slide from the second end to the first end.

18. The bottle of claim 16, wherein movement of the plunger within the cylindrical tube creates the pressure differential.

19. The bottle of claim 12, wherein the second valve comprises a bicuspid valve.

20. The bottle of claim 12, wherein the container comprises a collapsible bag.

21. The bottle of claim 12, wherein the pressure difference may be caused by a user squeezing the bottle.

22. The bottle of claim 12, wherein the first valve comprises a stopper comprising an aperture, and the pressure difference may be caused by a sucking on the stopper.

23. A method for selectively dispensing first and second liquids from a bottle, the method comprising:
coupling a cap to a mouth of the bottle, the cap comprising a first opening;
coupling a first valve to the first opening, the first valve comprising a first position, wherein the first liquid may be dispensed from the bottle, and a second position, wherein the first liquid is substantially sealed in the bottle;
coupling a container to the first opening, the container adapted to contain a second liquid and comprising a second opening;
inserting the container through the mouth into the bottle;
coupling a second valve to the second opening, the second valve adapted to close when a difference between a pressure inside the container and a pressure outside the container is less than a predetermined amount, and to open when the pressure difference is greater than the predetermined amount, wherein the second liquid may be dispensed from the container when the first valve is in the closed position.

24. The method of claim 23, wherein the container comprises a cylindrical tube.

25. The method of claim 24, wherein the cylindrical tube comprises a first end comprising an opening, and the method further comprises coupling the first end to the cap.

26. The method of claim 24, wherein the cylindrical tube comprises a second end comprising an opening, and the method further comprises removably inserting a bottom into the second end.

27. The method of claim 24, wherein the cylindrical tube comprises interior sidewalls, and the second container further comprises a plunger adapted to sealingly and slidably engage the interior sidewalls of the cylindrical tube.

28. The method of claim 27, wherein the cylindrical tube further comprises a second end comprising an opening, and the method comprises sliding the plunger from the second end to the first end.

29. The method of claim 27, wherein movement of the plunger within the cylindrical tube creates the pressure differential.

30. The method of claim 23, wherein the second valve comprises a bicuspid valve.

31. The method of claim 23, wherein the container comprises a collapsible bag.

32. The of claim 23, further comprising squeezing the bottle to cause the pressure difference.

33. The method of claim 23, wherein the first valve comprises a stopper comprising an aperture, and the method further comprises sucking on the stopper to cause the pressure difference.
